(19) United States
(12) Patent Application Publication
(10) Pub. No.: US 2008/0085387 A1
(43) Pub. Date: Apr. 10, 2008

(54) Electromagnetic shielding material, coaxial cable using the same, and method of making the same

(75) Inventors: Takashi AOYAMA, Hitachi (JP); Tomiya ABE, Hitachi (JP); Hidenori OKUZAKI, Kofu (JP); Yuzo ITO, Mito (JP)

Correspondence Address: SCULLY SCOTT MURPHY & PRESSER, PC, 400 GARDEN CITY PLAZA, SUITE 300, GARDEN CITY, NY, 11530, US

(73) Assignees: HITACHI CABLE, LTD., Tokyo (JP); UNIVERSITY OF YAMANASHI, Yamanashi (JP)

(21) Appl. No.: 11/894,153

(22) Filed: Aug. 20, 2007

(30) Foreign Application Priority Data
Sep. 22, 2006 (JP) 2006-257425

(51) Int. Cl. B29D 23/00; B05D 5/12

(52) U.S. Cl. 428/36.9; 427/78

(57) ABSTRACT

An electromagnetic shielding material is formed of a tubular electromagnetic shielding material made of a vinyl based conductive polymer fiber represented by formula (2). The tubular electromagnetic shielding material is produced by forming a tubular compact made of a vinyl based conductive polymer precursor fiber represented by formula (1), and heating the tubular compact to eliminate a leaving group from the precursor fiber. 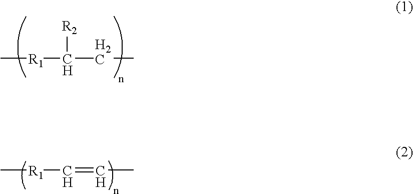
where R₁ represents an aromatic hydrocarbon group or a hetero hydrocarbon group, and R₂ represents the leaving group.

The present application is based on Japanese patent application No. 2006-257425, the entire contents of which are incorporated herein by reference.

### BACKGROUND OF THE INVENTION

1. Field of the Invention

This invention relates to an electromagnetic shielding material and, in particular, to an electromagnetic shielding material that can be applied to a cable-like product such as a coaxial cable. Also, this invention relates to a coaxial cable using an electromagnetic shielding material, and to a method of making an electromagnetic shielding material.

2. Description of the Related Art

Recently, medical device and electronics information device etc. are highly needed to be reduced in weight, size and thickness, and the cable used in the devices is also needed to be reduced in diameter furthermore.

Conventionally, a served shield material formed by winding metal single wires transversely and a braided shield material formed by braiding the metal single wires were used as an electromagnetic shielding material of a cable, but the reduction in diameter of the metal single wire have limitations, thus, the reduction in weight, size and thickness of the cable also have limitations.

Therefore, cables having a shielding material comprising metal thin film etc. are proposed (refer to e.g. Patent Literature 1, 2)

Patent Literature 1: JP-B-2929161

Patent Literature 2: JP-A-2002-203437

Patent Literature 3: JP-A-2005-330624

Patent Literature 4: JP-A-H08-96625

Patent Literature 5: JP-A-S64-38909

Patent Literature 6: JP-A-H04-355008

Patent Literature 7: JP-A-H05-325660

Patent Literature 8: JP-A-2005-93368

However, while the coaxial cable described in Patent Literature 1 has a high effect based on the reduction in diameter of the cable, the production process is extremely complex, so that the production cost is increased and there is a problem in mass productivity.

While the cable described in Patent Literature 2 has a high effect based on the reduction in outer diameter of the cable, a metal plating as a shielding material (a shielding layer) is directly disposed on a surface of an insulation layer, so that it is difficult to separate the shielding material from the insulation layer when the cable terminal is connected. Further, when the cable is bent repeatedly the metal plating breaks, so that there is a problem in also a repeated bending durability.

### SUMMARY OF THE INVENTION

It is an object of the invention to provide an electromagnetic shielding material used as a shielding material for a cable etc. which is capable of being reduced in weight, size and thickness, and comprise a good mass productivity and a good repeated bending durability.

It is a further object of the invention to provide a coaxial cable using an electromagnetic shielding material.

It is a furthermore object of the invention to provide a method of making an electromagnetic shielding material.

(I) According to one embodiment of the invention, an electromagnetic shielding material comprises:

a tubular electromagnetic shielding material comprising a vinyl based conductive polymer fiber represented by the following general formula (2), the tubular electromagnetic shielding material produced by forming a tubular compact comprising a vinyl based conductive polymer precursor fiber represented by the following general formula (1), heat-treating the tubular compact, and eliminating a leaving group from the precursor fiber. 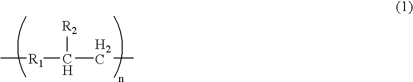
[Vinyl Based Conductive Polymer Precursor]
(In formula (1), R₁, comprises an aromatic hydrocarbon group or a hetero hydrocarbon group, and R₂ represents the leaving group.) 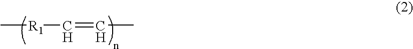
[Vinyl Based Conductive Polymer]
(In formula (2), R₁ comprises an aromatic hydrocarbon group or a hetero hydrocarbon group.)

In the above embodiment (I), the following modifications and changes can be made.

(i) The tubular electromagnetic shielding material comprises the vinyl based conductive polymer fiber doped with a dopant.

(ii) The dopant is sulfuric acid.

(iii) The vinyl based conductive polymer fiber comprises a diameter of several dozen nm to several μm.

(II) According to another embodiment of the invention, a coaxial cable uses the electromagnetic shielding material of the above embodiment (I) as an external conductor.

(III) According to another embodiment of the invention, a method of making an electromagnetic shielding material comprises the steps of:

dissolving a vinyl based conductive polymer precursor represented by the following general formula (1) in a solution including a volatile solvent,

rotating a target electrode comprising a metal core, and simultaneously spraying the vinyl based conductive polymer precursor fiber onto the target electrode by electro spinning, so as to form a tubular compact, and

heating the tubular compact to eliminate a leaving group from the precursor fiber, so as to form a tubular electromagnetic shielding material comprising a vinyl based conductive polymer fiber represented by the following general formula (2). 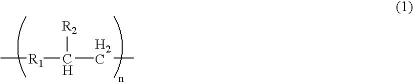
[Vinyl Based Conductive Polymer Precursor]
(In formula (1), R₁ comprises an aromatic hydrocarbon group or a hetero hydrocarbon group, and R₂ represents the leaving group.) 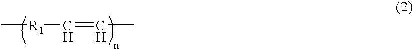
[Vinyl Based Conductive Polymer]
(In formula (2), R₁ comprises an aromatic hydrocarbon group or a hetero hydrocarbon group.)

(IV) According to another embodiment of the invention, a method of making an electromagnetic shielding material comprises the steps of:

dissolving a vinyl based conductive polymer precursor represented by the following general formula (1) in a solution including a volatile solvent,

rotating an insulation covered wire disposed between a solution side electrode and a target electrode, and simultaneously spraying the vinyl based conductive polymer precursor fiber onto the insulation covered wire by an electro spinning, so as to form a tubular compact, and

heating the tubular compact to eliminate a leaving group from the precursor fiber, so as to form a tubular electromagnetic shielding material comprising a vinyl based conductive polymer fiber represented by the following general formula (2). 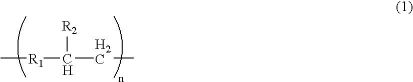
[Vinyl Based Conductive Polymer Precursor]
(In formula (1), R₁, comprises an aromatic hydrocarbon group or a hetero hydrocarbon group, and R₂ represents the leaving group.) 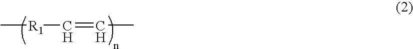
[Vinyl Based Conductive Polymer]
(In formula (2), R₁, comprises an aromatic hydrocarbon group or a hetero hydrocarbon group.)

In the above embodiments (III) and (IV), the following modifications and changes can be made.

(iv) The heat-treatment is conducted in vacuum or in the presence of inert gases.

### ADVANTAGES OF THE INVENTION

According to the invention, an electromagnetic shielding material used as a shielding material for a cable etc. which can be reduced in weight, size and thickness, and comprises a good mass productivity and a good repeated bending durability can be provided.

### BRIEF DESCRIPTION OF THE DRAWINGS

The preferred embodiments according to the invention will be explained below referring to the drawings, wherein:

FIG. 1 is a perspective view showing an electromagnetic shielding material in a preferred embodiment according to the invention;

FIG. 2 is an explanatory view schematically showing an electro spinning device used in a method of making an electromagnetic shielding material in a preferred embodiment according to the invention;

FIG. 3 is an explanatory view schematically showing an electro spinning device used in a method of making an electromagnetic shielding material in other preferred embodiment according to the invention;

FIG. 4 is a transverse cross-sectional view showing an example of an insulation covered wire.

FIG. 5 is a transverse cross-sectional view showing an example of a coaxial cable using the electromagnetic shielding material shown in FIG. 1.

FIG. 6 is an explanatory view schematically showing an example of an electro spinning device used in a method of making an electromagnetic shielding material in a preferred embodiment according to the invention;

FIG. 7 is an explanatory view schematically showing other example of an electro spinning device used in a method of making an electromagnetic shielding material in a preferred embodiment according to the invention; and

FIG. 8 is a transverse cross-sectional view showing an example of a conventional coaxial cable.

### DETAILED DESCRIPTION OF THE PREFERRED EMBODIMENTS

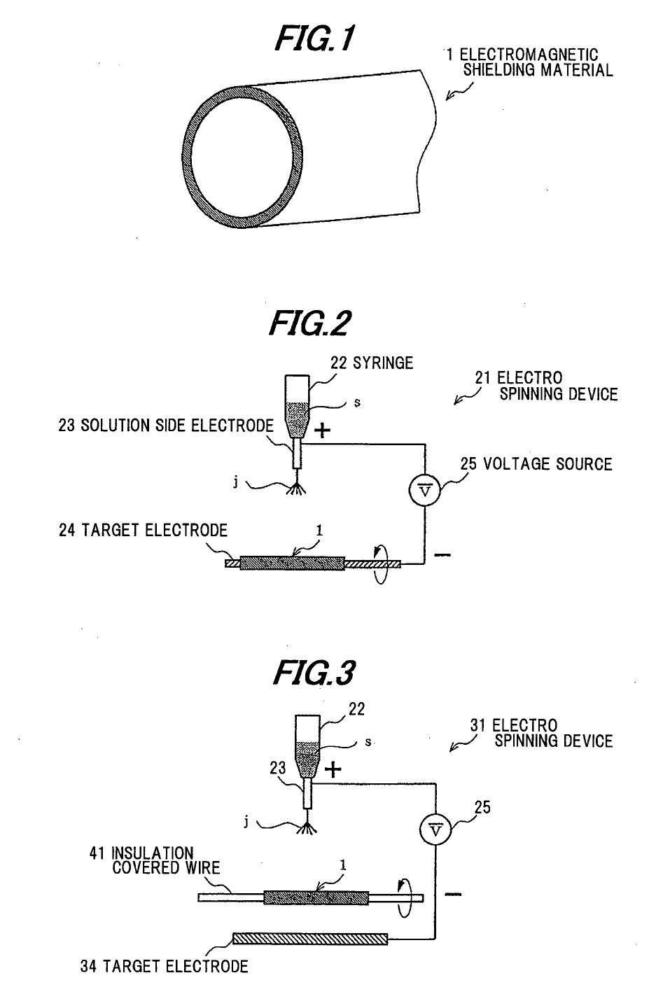

FIG. 1 is a perspective view showing an electromagnetic shielding material in a preferred embodiment according to the invention.

As shown in FIG. 1, an electromagnetic shielding material 1 in a preferred embodiment comprises a tubular electromagnetic shielding material comprising a vinyl based conductive polymer fiber represented by the following general formula (2), the tubular electromagnetic shielding material produced by forming a tubular compact comprising a vinyl based conductive polymer precursor fiber represented by the following general formula (1), heating the tubular compact to eliminate a leaving group from the precursor fiber. 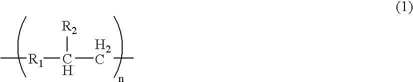
[Vinyl Based Conductive Polymer Precursor]
(In formula (1), R₁ is an aromatic hydrocarbon group or a hetero hydrocarbon group, and R₂ is the leaving group.) 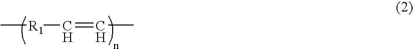
[Vinyl Based Conductive Polymer]
(In formula (2), R₁ is an aromatic hydrocarbon group or a hetero hydrocarbon group.)

Further, a vinyl based conductive polymer precursor means a precursor of vinyl based conductive polymer which can form vinyl group by elimination of side chain, of polymer compounds including aromatic hydrocarbon or hetero hydrocarbon in main chain.

Furthermore, a vinyl based conductive polymer means a conductive polymer in which side chain of a vinyl based conductive polymer precursor is eliminated and forms vinyl group, and which is fibrous.

In particular, it is preferable that the following groups are used as R₁ and R₂ in formula (1) or (2). 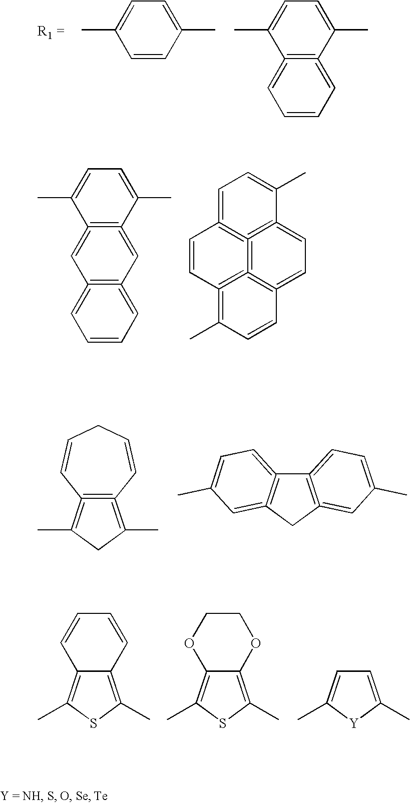
R₂=S⁺(CH₃)₂X⁻, S⁺(C₂H₅)₂X⁻, S⁺(C₃H₇)₂X⁻, S⁺(CH₂)₄X⁻, OCH₃, OC₂H₅, OC₃H₇
X⁻=Cl⁻, Br⁻, I⁻, OH⁻

That is, R₁ includes at least one selected from the group consisting of benzene, naphthalene, anthracene, pyrene, azulene, fluorene, isothianaphthene, ethylenedioxythiophene, pyrrole, thiophene, furan, selenophene, tellurophene, and derivatives thereof. Of these, benzene is preferable, since it comprises a high stability and reliability, and is easily synthesized. If R₁ is benzene, formula (2) is poly(p-phenylenvinylene), hereinafter referred to as “PPV”.

R₂ includes: at least one selected from the group consisting of alkylsulfonium salt such as dimethylsulfonium salt, diethylsulfonium salt, dipropylsulfonium salt and tetrahydrothiophenium salt; alkoxy group such as methoxy group, ethoxy group and propoxy group; and derivatives thereof. X includes at least one of halide ion such as chloride ion, bromide ion, iodide ion and hydroxide ion. Of these, tetrahydrothiophenium chloride is preferable, since it is easily synthesized and comprises a high reliability.

The tubular electromagnetic shielding material can be formed by adding a dopant to the vinyl based conductive polymer fiber.

When an operation of adding the dopant to the vinyl based conductive polymer fiber (a doping operation) is conducted, electrical conductivity of the vinyl based conductive polymer fiber is remarkably increased than that before conducting the doping operation. The dopant used for the doping operation includes at least one selected from the group consisting of sulfuric acid, hydrochloric acid, phosphoric acid, iodine, bromine, arsenic fluoride, perchloric acid, tetrafluoroboric acid, hexafluorophosphoric acid, toluenesulfonic acid, dodecylbenzenesulfonic acid, perfluorosulfonic acid, polystyrenesulfonic acid, and derivatives thereof. Of these, sulfuric acid is preferable, since it can easily adjust a high electrically conductive property.

It is preferable that the vinyl based conductive polymer fiber comprises a diameter of several dozen nm to several μm, since if within the range, the electromagnetic shielding material 1 can be reduced in thickness than ever before.

Hereinafter, an electro spinning device to conduct electro spinning will be explained referring to FIG. 2.

The electro spinning means a method of conducting spinning by using a high voltage. The principle of the method is described below. When the high voltage is applied, electrical charges are induced and accumulated in a surface of raw material solution. These electrical charges repel each other, and the repelling power opposes the surface tension of the solution. When the electrical field force exceeds the critical value, the repelling power of the electrical charges exceeds the surface tension, so that a jet of the charged solution is sprayed. The sprayed jet comprises a large surface area for volume, so that solvent is efficiently vaporized, and charge density is increased by decrease in volume, so that the jet is split into further smaller jet. The method comprises the steps described above, and by the steps the fiber can be made from the raw material solution

As shown in FIG. 2, an electro spinning device 21 comprises a syringe 22 storing a solution s including a vinyl based conductive polymer precursor represented by the general formula (1), a solution side electrode 23 to spray the solution s down below, mounted on the lower portion of the syringe 22 and comprising a nozzle-like shape, a target electrode 24 mounted in the vertically lower portion of the solution side electrode 23 while facing to the electrode 23, and comprising a bar-like shape to which the charged droplets sprayed from the solution side electrode 23 are blasted, and a voltage source 25 to apply a high voltage between both electrodes 23, 24.

In the example of the electro spinning device 21, the syringe 22 is disposed in the upper side, the solution side electrode 23 is disposed in the lower portion of the syringe 22, and the target electrode 24 is disposed in the lower portion of the solution side electrode 23, so that if the voltage is not applied between both electrodes 23, 24, the solution s falls in drops having a certain volume by gravity.

The solution side electrode 23 is disposed to be movable in the up-and-down direction and slidable in the horizontal (left-and-right in FIG. 2) direction. Simultaneously, the target electrode 24 is also disposed to be movable in the up-and-down direction and slidable in the horizontal direction. Further, the target electrode 24 is disposed rotatably around the axis. The voltage source 25 applies the voltage so as to become positive in the side of the solution side electrode 23 and negative in the side of target electrode 24.

The target electrode 24 comprising a metal core is used. The wiring between the target electrode 24 and the voltage source 25 is conducted through e.g. a collector ring. In the electro spinning device 21, by using the voltage source 25, the voltage is applied between both electrodes 23, 24, but instead of this, a charging device to charge (electrify) the solution s can be installed in the target electrode 24 and simultaneously, an accelerating electrode to accelerate the charged droplets down below can be installed near to the lower portion of the solution side electrode 23.

If the voltage applied to both electrodes 23, 24 is low, the repelling power can not overcome the surface tension of the solution s to fall in drops from the solution side electrode 23, and the jet j of the solution s can not be formed, or even if the jet j can be formed, the charging of the droplets is not sufficient, so that the solvent is not vaporized perfectly until the jet j reaches the target electrode 24, and a good nano or micro fiber can not be obtained.

Therefore, in consideration of stability of the jet j and volatility of the solvent, it is preferable that the applied voltage is controlled to be 10 to 30 kV.

The diameter of the vinyl based conductive polymer fiber can be controlled to arbitrary size by adequately adjusting applied voltage, each concentration of the precursor and the solvent in the solution s, shape of the nozzle of the solution side electrode 23, and distance between both electrodes 23, 24.

Next, a method of making the electromagnetic shielding material 1 will be explained.

The method of making the electromagnetic shielding material 1 in the preferred embodiment is conducted by using the electro spinning device 21 explained in FIG. 2. In particular,

The method comprises the steps of:

dissolving a vinyl based conductive polymer precursor represented by the above general formula (1) in a solution including a volatile solvent,

rotating a target electrode 24, and simultaneously spraying the vinyl based conductive polymer precursor fiber onto the outer circumference of the target electrode 24 by an electro spinning, so as to form a tubular compact, and

heating the tubular compact to eliminate a leaving group of the precursor fiber, so as to form a tubular electromagnetic shielding material comprising a vinyl based conductive polymer fiber represented by the above general formula (2).

In order to form a vinyl based conductive polymer fiber, first, a vinyl based conductive polymer precursor is dissolved in a solution comprising water, pure water, volatile solvent, or mixed solvent thereof. The volatile solvent includes at least one selected from a group consisting of alcohols, ketones, aldehydes, nitrites, ethers, dimethylformamides and monoalkyl halides.

When the electro spinning is applied to a solution s using a mixed solvent of water and methanol as a solvent, if the methanol content of the solution s is 0 to 99 weight %, nano or micro fiber can be formed, but if the methanol content is low, the precursor strongly keep water, so that when the fiber adheres to the target electrode 24, the solvent remains therein. On the other hand, if the methanol content is too high, the concentration of the precursor is too low, so that the fiber can not be formed.

Therefore, in consideration of dry condition and production speed of the fiber to be obtained, it is preferable that the methanol content of the solution s is controlled to 40 to 90 weight %.

The step of forming the tubular compact is conducted while the solution side electrode 23 and the target electrode 24 are slid.

It is preferable that the heat-treatment is conducted in vacuum or in the presence of inert gases. If the precursor fiber is heat-treated in vacuum or in the presence of inert gases, the precursor fiber becomes the vinyl based conductive polymer fiber comprising vinyl group formed by elimination of side chains. However, the precursor fiber is heat-treated in the atmosphere, deterioration etc. due to thermal decomposition and oxidation occurs, so that strength and electrical conductivity of the fiber is reduced.

When the tubular compact is heat-treated and the target electrode 24 is pulled out, the electromagnetic shielding material 1 shown in FIG. 1 is obtained.

Hereinafter, a function of the preferred embodiment will be explained.

The electromagnetic shielding material 1 comprises a tubular electromagnetic shielding material comprising a vinyl based conductive polymer fiber produced by forming a tubular compact comprising a vinyl based conductive polymer precursor by using the target electrode 24 comprising a bar-like or prismatic shape, heating the tubular compact to eliminate a leaving group from the precursor fiber.

Conventionally, the target electrode comprises a plate-like shape and only a fiber comprising a sheet-like shape can be formed on the target electrode, but the target electrode 24 comprising a bar-like shape is used, so that a tubular (circular tubular or polygonal tubular) electromagnetic shielding material can be easily formed on an outer circumference of the target electrode 24, and the shielding material can be reduced in size and thickness in comparison with conventional shielding material.

Further, the electromagnetic shielding material 1 comprises the vinyl based conductive polymer fiber assembly, so that it has a good repeated bending durability.

Furthermore, while conventional shielding material comprises metal, the electromagnetic shielding material 1 comprises the conductive polymer fiber instead of metal, so that the shielding material can be also reduced in weight.

According to the making method in the preferred embodiment, the electro spinning is conducted while the target electrode 24 comprising a metal core is rotated, so that a tubular shielding material can be easily formed on the outer circumference of the target electrode 24. Further, if the target electrode 24 is changed or replaced, the existing electro spinning device can be used at the minimum change and replacement of the parts.

If the electromagnetic shielding material 1 is used as an external conductor (a shielding layer), a coaxial cable 51, for example shown in FIG. 1, is obtained. The coaxial cable 51 comprises a central conductor 53 formed by a plurality of single wires 52 being twisted together, an insulation layer 54 disposed on an outer circumference of the central conductor 53, the electromagnetic shielding material 1 disposed on an outer circumference of the insulation layer 54, and an jacket 55 disposed on an outer circumference of the electromagnetic shielding material 1.

It is preferable that as the insulation layer 54 fluorine resin (e.g. PFT) and silicone rubber which comprise a high heat resistance are used, because it is needed that the insulation layer 54 is protected from the thermal damage due to the heat-treatment at forming the electromagnetic shielding material 1.

The coaxial cable 51 using the electromagnetic shielding material 1 can be reduced in weight, diameter and thickness in comparison with conventional shielding material using metal single wire or metal plating as an external conductor, and can be easily made, so that the cable 51 has a good mass productivity and a good repeated bending durability.

Further, the electromagnetic shielding material 1 comprises the same properties as polymer material except for comprising conductive property, so that the terminal workability of the coaxial cable 51 can be enhanced.

The electromagnetic shielding material 1 can be used as an external conductor of a coaxial cable. Therefore, it can be also formed to a tube-like shape by using a cylindrical object to be sprayed such as an insulation covered wire.

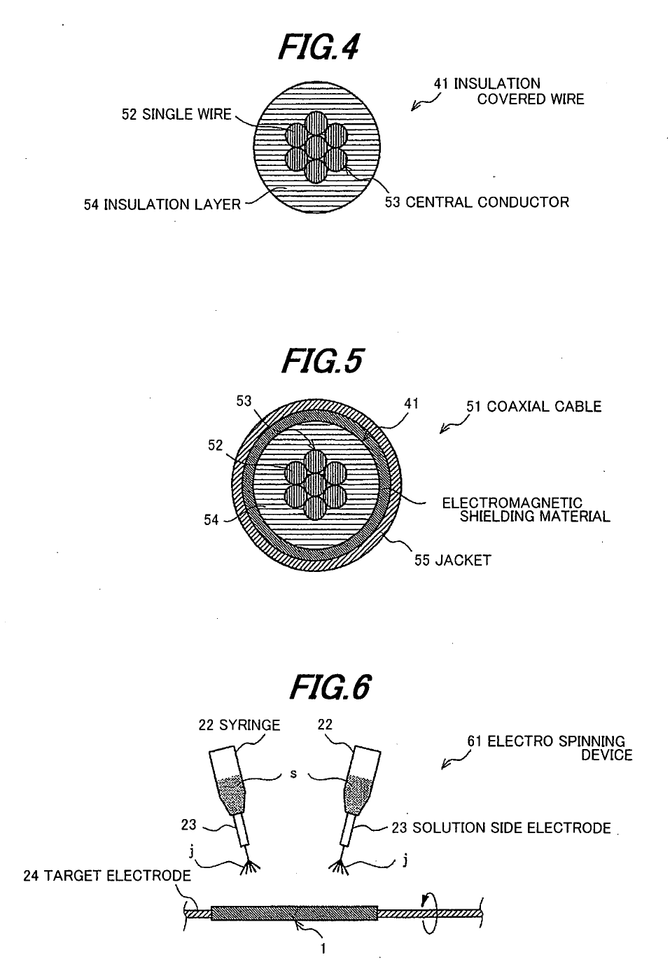

The insulation covered wire includes the insulation covered wire 41 shown in FIG. 4, for example, if it is desired that the coaxial cable 51 shown in FIG. 5 is obtained. The insulation covered wire 41 comprises the central conductor 53 formed by a plurality of single wires 52 being twisted together, and the insulation layer 54 disposed on an outer circumference of the central conductor 53.

Next, a method of making the electromagnetic shielding material 1 using an insulation covered wire.

In the making method, an electro spinning device 31 shown in FIG. 4 is used. The electro spinning device 31 comprises a target electrode 34 comprising a metal plate, and the insulation covered wire 41 disposed between the target electrode 34 and the solution side electrode 23 rotatably and to be slidable in the longitudinal direction, the insulation covered wire 41 being used to form the tubular electromagnetic shielding material 1. The device 31 comprises the same other structure as the device 21 shown in FIG. 2.

The device 31, while not shown in detail, comprises a holding portion to hold both ends of the insulation covered wire 41, a rotation means to rotate the holding portion, so as to rotate the insulation covered wire 41 around the axis, and a moving means to slide and move the holding portion.

Method of making the electromagnetic shielding material 1 using the insulation covered wire comprises the steps of:

dissolving the vinyl based conductive polymer precursor represented by the above general formula (1) in a solution including a volatile solvent,
rotating the insulation covered wire 41 disposed between the solution side electrode 23 and the target electrode 34, and simultaneously spraying the vinyl based conductive polymer precursor fiber onto the insulation covered wire 41 by an electro spinning, so as to form a tubular compact, and
heating the tubular compact to eliminate a leaving group from the precursor fiber, so as to form the tubular electromagnetic shielding material comprising the vinyl based conductive polymer fiber represented by the above general formula (2).

The step of forming the tubular compact is conducted while the solution side electrode 23 or the insulation covered wire 41 is slid.

The diameter of the vinyl based conductive polymer fiber can be controlled to arbitrary size by adequately adjusting applied voltage, each concentration of the precursor and the solvent in the solution s, shape of the nozzle of the solution side electrode 23, distance between both electrodes 23, 24, and distance between the solution side electrode 23 and the insulation covered wire 41.

The making method using the device 31 has basically the same content as the making method using the device 21 shown in FIG. 2.

The method of making the electromagnetic shielding material using the insulation covered wire 41 can also easily provide the tubular electromagnetic shielding material 1. In the method, the tubular electromagnetic shielding material 1 is directly formed on the outer circumference of the insulation covered wire 41, so that particularly, it is more effective in the case of using the electromagnetic shielding material 1 as the external conductor of the coaxial cable, and the coaxial cable 51 shown in FIG. 5 can be easily made.

Hereinafter, other example of the electro spinning device used in the method of making the electromagnetic shielding material 1 shown in FIG. 1 will be explained.

The electro spinning device 61 shown in FIG. 6 is used for making of the electromagnetic shielding material 1 comprising a long size. The electro spinning device 61 comprises a plurality of syringes 22 (FIG. 6 shows a case of two syringes 22) installed over the target electrode 24 comprising a bar-like shape and a long size, along the length direction of the target electrode 24, on which each of the solution side electrodes 23 is mounted at the lower portion, in addition to the construction of the device 21 shown in FIG. 2.

If the device 61 is used, the electromagnetic shielding material 1 comprising a long size can be efficiently and easily formed by spraying the precursor fiber onto the outer circumference of the target electrode 24 by a plurality of the syringes 22 with the solution side electrodes 23, so as to form a tubular compact, and heat-treating the tubular compact.

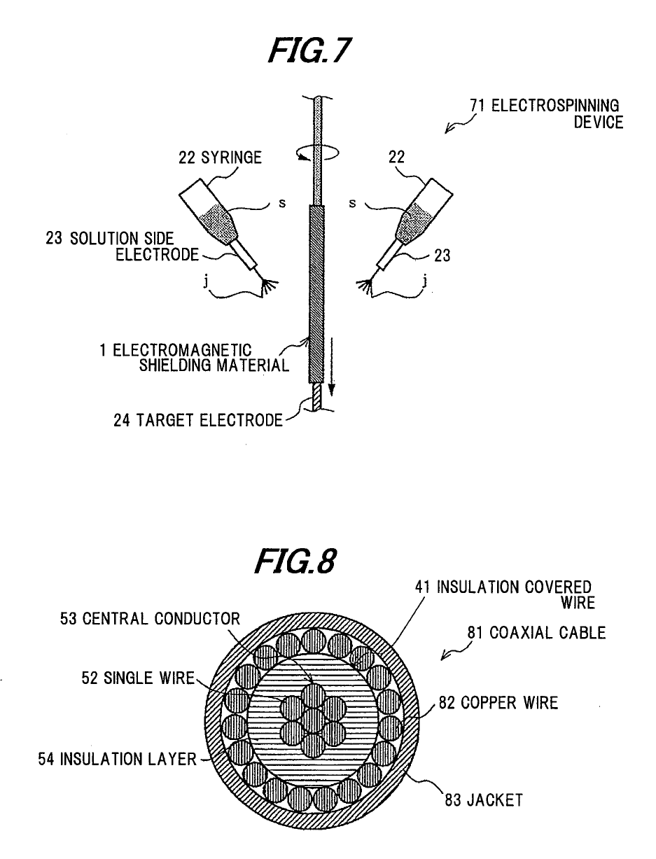

If the electromagnetic shielding material 1 comprising a long size is made, the electro spinning device 71 shown in FIG. 7 can be also used. The electro spinning device 71 comprises a moving means to move the target electrode 24 comprising a bar-like shape and a long size in the lengthwise (vertical) direction or in the crosswise (horizontal) direction (FIG. 7 shows a case of lengthwise direction), and a plurality of the syringes 22 (FIG. 7 shows a case of two syringes 22) with the solution side electrodes 23, the syringes 22 being installed in both sides of the target electrode 24 along the length direction of the target electrode 24, in addition to the construction of the device 21 shown in FIG. 2.

Also in the device 71, the electromagnetic shielding material 1 comprising a long size can be efficiently and easily formed by rotating and simultaneously moving the target electrode 24, spraying the precursor fiber onto the outer circumference of the target electrode 24 by a plurality of the syringes 22 with the solution side electrodes 23, so as to form a tubular compact, and heat-treating the tubular compact.

Further, if the an electro spinning device similar to the device 61 shown in FIG. 6 and the device 71 shown in FIG. 7 is used in addition to the construction of the device 31 shown in FIG. 3, the electromagnetic shielding material 1 comprising a long size using the insulation covered wire 41 can be efficiently and easily formed.

### EXAMPLE 1

In Example 1, the electromagnetic shielding material 1 was made by using the device 21 shown in FIG. 2. Water solution (2.5%) of poly(paraxylenetetraliydrothiopheniumchloride) (Aldrich, 54076-5) which is a precursor of PPV, was used as the vinyl based conductive polymer precursor. A solution being prepared by adding methanol (60%) as the volatile solvent to the water solution of the vinyl based conductive polymer precursor was used.

A copper wire of 0.110 mm in diameter was used as the target electrode 24 comprising the metal core. And, the target electrode 24 was rotated at the rotation speed of 10 rpm, simultaneously a direct current voltage of 20 kV was applied, and the electro spinning was conducted at 200 mm as the distance between the electrodes 23, 24 for 30 seconds. As a result, PPV precursor fiber comprising a tube-like shape and a thickness of 0.010 mm was piled on the outer circumference of the target electrode 24.

After that, the tubular PPV precursor fiber was heat-treated in vacuum at 250° C. for 8 hours, and a tubular PPV fiber was obtained. The target electrode 24 was pulled out, and the tubular electromagnetic shielding material 1 was obtained, the shielding material 1 comprising an inner diameter of 0.110 mm and a thickness of 0.010 mm, and comprising the PPV fiber.

The shielding material 1 was doped with sulfuric acid, so that the tubular electromagnetic shielding material 1 comprising a high conductive property was obtained.

The insulation covered wire 41 was covered with the tubular electromagnetic shielding material 1 being obtained, the insulation covered wire 41 comprising the central conductor 53 formed by that seven copper wires comprising a single wire diameter of 0.020 mm are twisted, and the insulation layer 54 comprising fluororesin (PFA resin) and a thickness of 0.025 mm and being formed by an extrusion molding on the outer circumference of the central conductor 53, and the insulation covered wire 41 covered with the shielding material 1 was covered with PFA resin as the jacket 55, so that the coaxial cable 51 comprising an outer diameter of 0.180 mm was obtained.

When the terminal work was conducted to the coaxial cable 51, the electromagnetic shielding material 1 was easily separated from the insulation covered wire 41, so that the connecting work was easily achieved. Further, bending of 1 mm in a diameter was repeated 1000 times to the coaxial cable 51, but breakage of the electromagnetic shielding material 1 was not observed.

### Example 2

In EXAMPLE 2, the electromagnetic shielding material 1 was made by using the device 31 shown in FIG. 3. A solution being prepared by adding methanol (70%) to the water solution of the vinyl based conductive polymer precursor, the same water solution as Example 1, was used.

A copper plate comprising a length of 300 mm, a width of 300 mm and a thickness of 2 mm was used as the target electrode 34. Further, the insulation covered wire 41 comprising an outer diameter of 0.110 mm was used, the insulation covered wire 41 comprising the central conductor 53 formed by that seven copper wires comprising a single wire diameter of 0.018 mm are twisted, and the insulation layer 54 comprising fluororesin (PFA resin) and a thickness of 0.028 mm and being formed by an extrusion molding on the outer circumference of the central conductor 53. And, in a condition of distance between electrodes 23, 34 being 300 mm and distance from the solution side electrode 23 to the insulation covered wire 41 being 250 mm, the insulation covered wire 41 was rotated at the rotation speed of 5 rpm, simultaneously a direct current voltage of 20 kV was applied, and the electro spinning was conducted for 30 seconds. As a result, PPV precursor fiber comprising a thickness of 0.010 mm was piled on the outer circumference of the insulation covered wire 41.

After that, the insulation covered wire 41 piled by the tubular PPV precursor fiber was heat-treated in vacuum at 220° C. for 12 hours, and a product comprising the insulation covered wire 41 and the PPV fiber piled on the outer circumference of the insulation covered wire 41 as the electromagnetic shielding material 1 was obtained. The PPV fiber of the product was doped with sulfuric acid, so that the electromagnetic shielding material 1 comprising a high conductive property was obtained. After that, the doped product was covered with PFA resin comprising a thickness of 0.025 mm as the jacket 55, so that the coaxial cable 51 comprising an outer diameter of 0.180 mm was obtained.

### COMPARATIVE EXAMPLE 1

A copper plating of 0.010 mm in thickness was disposed on the same insulation covered wire 41 as Example 1, and as well as Example 1, the plated insulation covered wire 41 was covered with PFA resin comprising a thickness of 0.02 mm as the jacket, so that the coaxial cable comprising an outer diameter of 0.180 mm was obtained.

When the terminal work was conducted to the coaxial cable, it was difficult for the shielding material to be separated from the insulation covered wire. Further, bending of 1 mm in a diameter was repeated 1000 times to the coaxial cable, and breakage of the shielding material was observed.

### COMPARATIVE EXAMPLE 2

As shown in FIG. 8, a copper wire 82 comprising a single wire diameter of 0.020 mm was crossly wound on the same insulation covered wire 41 as Example 2, so as to form the external conductor, as well as Example 2, the wound insulation covered wire 41 was covered with PFA resin comprising a thickness of 0.02 mm as the jacket 83, so that the coaxial cable 81 comprising an outer diameter of 0.200 mm shown in FIG. 8 was obtained.

As a result, the coaxial cable 51 of Example 2 can be reduced in the outer diameter by 10% in comparison with that of the coaxial cable 81 of Comparative Example 2, and can be reduced in the weight by 7%. In particular, if the electromagnetic shielding material of the invention is used for medical probe cable comprising several hundred of the coaxial cables 51 which are bound together, a remarkable reduction in weight, diameter and thickness can be achieved in comparison with the conventional probe cable.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An electromagnetic shielding material, comprising:
a tubular electromagnetic shielding material comprising a vinyl based conductive polymer fiber represented by the following general formula (2), the tubular electromagnetic shielding material produced by forming a tubular compact comprising a vinyl based conductive polymer precursor fiber represented by the following general formula (1), and heating the tubular compact to eliminate a leaving group from the precursor fiber. 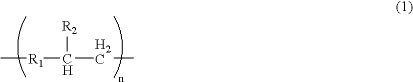
(In formula (1), R₁, comprises an aromatic hydrocarbon group or a hetero hydrocarbon group, and R₂ represents the leaving group.) 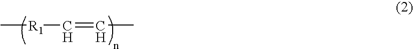
(In formula (2), R₁ comprises an aromatic hydrocarbon group or a hetero hydrocarbon group.)

2. The electromagnetic shielding material according to claim 1, wherein:
the tubular electromagnetic shielding material comprises the vinyl based conductive polymer fiber doped with a dopant.

3. The electromagnetic shielding material according to claim 2, wherein:
the dopant comprises sulfuric acid.

4. The electromagnetic shielding material according to claim 1, wherein:
the vinyl based conductive polymer fiber comprises a diameter of several dozen nm to several μm.

5. A coaxial cable, comprising:
an external conductor comprising the electromagnetic shielding material according to claim 1.

6. A method of making an electromagnetic shielding material comprising the steps of:
dissolving a vinyl based conductive polymer precursor represented by the following general formula (1) in a solution including a volatile solvent,
rotating a target electrode comprising a metal core, and simultaneously spraying the vinyl based conductive polymer precursor fiber onto the target electrode by an electro spinning, so as to form a tubular compact, and
heating the tubular compact to eliminate a leaving group from the precursor fiber, so as to form a tubular electromagnetic shielding material comprising a vinyl based conductive polymer fiber represented by the following general formula (2). 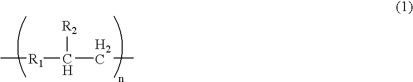
(In formula (1), R₁ comprises an aromatic hydrocarbon group or a hetero hydrocarbon group, and R₂ represents the leaving group.) 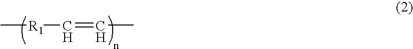
(In formula (2), R₁ comprises an aromatic hydrocarbon group or a hetero hydrocarbon group.)

7. A method of making an electromagnetic shielding material comprising the steps of:
dissolving a vinyl based conductive polymer precursor represented by the following general formula (1) in a solution including a volatile solvent,
rotating an insulation covered wire disposed between a solution side electrode and a target electrode, and simultaneously spraying the vinyl based conductive polymer precursor fiber onto the insulation covered wire by an electro spinning, so as to form a tubular compact, and
heating the tubular compact to eliminate a leaving group from the precursor fiber, so as to form a tubular electromagnetic shielding material comprising a vinyl based conductive polymer fiber represented by the following general formula (2). 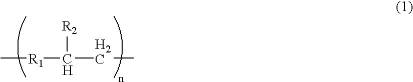
(In formula (1), R₁ comprises an aromatic hydrocarbon group or a hetero hydrocarbon group, and R₂ represents the leaving group.) 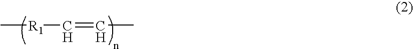
(In formula (2), R₁ comprises an aromatic hydrocarbon group or a hetero hydrocarbon group.)

8. The method according to claim 6, wherein:
the heating step is conducted in vacuum or in the presence of an inert gas.

9. The method according to claim 7, wherein:
the heating step is conducted in vacuum or in the presence of an inert gas.
